(19) United States
(12) Patent Application Publication
(10) Pub. No.: US 2017/0182426 A1
(43) Pub. Date: Jun. 29, 2017

(54) CAPTURE AND DELIVERY OF ONLINE GAMES SPECTATORS PERSONALIZED COMMENTARIES TO PLAYERS

(71) Applicant: InterDigital Patent Holdings, Inc., Wilmington, DE (US)

(72) Inventors: Shoshana Loeb, Philadelphia, PA (US); Gregory S. Sternberg, Mt. Laurel, NJ (US)

(73) Assignee: InterDigital Patent Holdings, Inc., Wilmington, DE (US)

(21) Appl. No.: 15/300,411

(22) PCT Filed: Apr. 1, 2015
(86) PCT No.: PCT/US2015/023908

§ 371 Date: Sep. 29, 2016

Related U.S. Application Data
(60) Provisional application No. 61/973,789, filed on Apr. 1, 2014.

(51) Int. Cl. A63F 13/87; H04N 21/4788; H04N 21/81; H04N 21/45; A63F 13/86; A63F 13/352

(52) U.S. Cl. CPC A63F 13/87; A63F 13/86; A63F 13/352; H04N 21/8133; H04N 21/8173; H04N 21/4508; H04N 21/4788; A63F 2300/572; A63F 2300/577

(57) ABSTRACT

Systems, methods, and instrumentalities are disclosed to establish an interface between a player of an application (such as an online game) and a spectator viewing the application such that the spectator provides at least one commentary (such as an audio or written message). The commentary may be synchronized with a temporal location in media associated with the application. The player may set criteria for the type of commentary to be received, as well as timing. The commentary may be filtered, wherein, if the commentary satisfies the filter conditions, the commentary is provided to the player. A discovery mechanism may allow spectators, players, and users of a social network who may watch a game offline to find comments relevant to the game. Players may be able to filter comments from individual spectators or from groups (e.g., types or classes) of spectators.

### CROSS-REFERENCE TO RELATED APPLICATIONS

This application claims the benefit of U.S. Provisional Patent Application No. 61/973,789, filed Apr. 1, 2014, the disclosure of which is incorporated herein by reference in its entirety.

### BACKGROUND

Online gaming has increasingly become a spectator activity. Applications may facilitate spectators following online games. Some applications may allow spectators to choose camera angles in a virtual game world to customize their view of the action. For example, one may be an observer in a MINECRAFT® game and may follow individual players, and may choose camera angles on the camera.

In addition to the ability to follow online games in real time, spectators may be able to chat with one another using social media platforms, such as Twitter, or through other social chat services during the game similarly to chatting about live televised events. For example, in the BATTLEFIELD® game, one may participate in a social network that may be associated with the game and may create a group of friends with whom one is connected. A shared, rich, time-shifted, connected media experience may be implemented. Users, e.g., end users may experience a rich media experience that may allow them to experience the underlying media and overlaid comments in synchronicity, which may provide greater temporal and/or spatial context for the comments.

### SUMMARY

Systems, methods, and instrumentalities are disclosed that may allow spectators of online games to send messages to game players. For example, an interface between a player of an application (such as an online game) and a spectator viewing the application may be established such that the spectator provides at least one commentary (such as an audio or written message). The commentary may be synchronized with a temporal location in media associated with the application. The player may set criteria (e.g., a criterion) for the type of commentary to be received, as well as timing. The commentary may be filtered, wherein, if the commentary satisfies the filter conditions, the commentary is provided to the player.

Game players may control, e.g., automatically control, which messages they receive. A commentary production environment may allow spectators to type while watching a game to create comments. When a spectator publishes the comment (e.g., clicks on “publish,” etc.), the comment may be synchronized to that point in time with the game. A discovery mechanism may allow spectators, players, and users of a social network who may watch a game offline to find comments relevant to the game. Players may be able to filter comments from individual spectators or from groups (e.g., types or classes) of spectators.

A commentary server may provide commentary to a user of an application by receiving a comment from a spectator, synchronizing the comment with a temporal location in a media of the application, and sending the comment to a user of the application.

### BRIEF DESCRIPTION OF THE DRAWINGS

FIG. 1 is a diagram of an example game system.

FIG. 2 is a diagram of an example of evaluating commentaries which may be selected to be forwarded to a player.

FIG. 3A is a system diagram of an example communications system in which one or more disclosed embodiments may be implemented.

FIG. 3B is a system diagram of an example wireless transmit/receive unit (WTRU) that may be used within the communications system illustrated in FIG. 3A.

FIG. 3C is a system diagram of an example radio access network and an example core network that may be used within the communications system illustrated in FIG. 3A.

FIG. 3D is a system diagram of another example radio access network and another example core network that may be used within the communications system illustrated in FIG. 3A.

FIG. 3E is a system diagram of another example radio access network and another example core network that may be used within the communications system illustrated in FIG. 3A.

### DETAILED DESCRIPTION

A detailed description of illustrative embodiments will now be described with reference to the various Figures. An online game commentary system may lack a spectator-to-player interface, or social media sites may not allow players to filter messages by content, etc. But in accordance with the example commentary systems herein, these problems may be remediated. Although the description provides a detailed example of possible implementations, it should be noted that the details are intended to be exemplary and in no way limit the scope of the application.

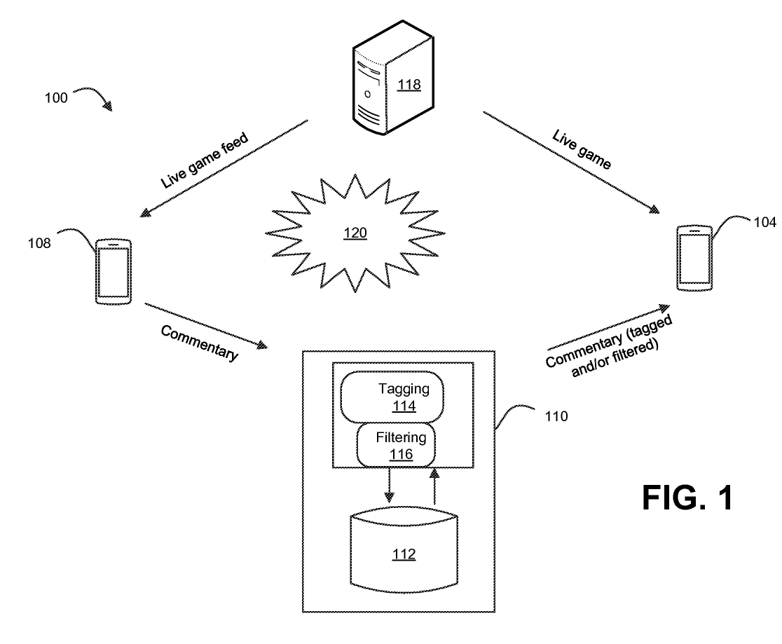

FIG. 1 is an example of a system that may allow spectators (for example, those watching an online game) to communicate with individual online game players. Communication may take place in real time. A game player may be able to filter and select which messages he or she would like to receive and when he or she would like to receive them. Filtering of incoming messages may be based on attributes such as the sender of the message, the content of the message, the content and/or state of the player in the game (e.g., busy, needs help, would like to chat). The system may allow a game player to view the commentaries offline and/or as part of watching the game in a replayed mode.

Spectators of an online game may have the ability to send commentaries to online game players, e.g., in real time. Game players may filter, e.g., automatically filter, messages sent to them based on a variety of criteria, such as the content and the identity and/or type of the sender. Game players may receive comments in real time or offline, e.g., after a gaming session has been completed.

Systems, methods, and instrumentalities are disclosed that may allow spectators of online games to send messages to game players and for the game players to control, e.g., automatically, which messages they receive. These messages may be referred to as commentaries or comments. A spectator may generate comments that may not be public and that may be visible by the player or players to whom the comments are addressed.

A commentary production environment may allow spectators to type while watching a game to create comments. When a spectator publishes the comment (e.g., clicks on “publish,” etc.), the comment may be synchronized to that point in time with the game. A discovery mechanism may allow spectators, players, and users of a social network who may watch a game offline to find comments relevant to the game.

Players may be able to filter comments from individual spectators or from groups (e.g., types or classes) of spectators. Comments may be categorized according to attributes such as spectator name, player name, sentiment, state of the game, etc. Commentary may be delivered in real time for simultaneous commentary viewing and/or game playing. A comment may be an individually addressable atomic unit that may be delivered on its own. Filtering may be used to select a subset of available comments to be displayed.

FIG. 1 illustrates an example game system 100. A game player (not illustrated) may play a game (such as an online game from a game server 118) using a game playing user interface (UI) executing on a user device 104. Examples of user devices 104 include examples such as wireless transmit/receive units (WTRUs), portable gaming devices, gaming consoles, personal computers, or other user devices capable of game play. A game spectator (not illustrated) may watch the game (for example, watching an online game being played in real time) using a game viewing UI executing on a user device 108. Examples of user devices 108 include examples such as WTRUs, personal computers, portable gaming devices, gaming consoles, network-connected televisions, or other devices capable of displaying a game feed and supporting a user interface.

A game player and/or a game spectator may have an application, e.g., a commentary application, executing on one or more of devices 104, 108. A commentary server 110 may receive commentaries from game spectator(s) device(s) 108 and/or provide commentaries to game player(s) device(s) 104.

Commentaries may be stored in a database 112. Information relating to game players and/or game spectators may be stored in the database 112. The commentary server 110 may comprise subsystems, including, for example, a tagging subsystem 114, a filtering subsystem 116, and/or the like. The tagging subsystem 114 may associate tags with commentaries. The tagging subsystem 114 may allow a game player and/or a game spectator to associate tags with commentaries.

The filtering subsystem 116 may apply a filter or filters to commentaries. The filtering subsystem 116 may control (for example, pursuant to preselected criteria) which commentaries the game player may view and/or when the game player may view commentaries. The filtering subsystem 116 may allow a game player to apply a filter or filters to commentaries to control which commentaries the game player may view, and when the game player may view commentaries.

The game system 100 may allow a game spectator or a game player to send commentaries to another game player. The game system 100 may allow a user device 104 operated by a game player to be switched into a spectator mode and to view a game from the perspective of another game player.

The commentary server 110 may be physically distinct from and in communication with the game server 118 via a communication network 120, such as the Internet. The commentary server 110 may be integrated into the same physical server as the game server 118 and may be logically distinct from the game server 118. For example, the commentary server 110 may be implemented as a game server 118 operating in a commentary mode of operation.

The game spectator, e.g., the user device 108 operated by the game spectator, may use a commentary input user interface to input and send commentaries to a game player, e.g., a user device 104 operated by a game player, through the commentary server 110.

The game player, e.g., the user device 104 operated by the game player, may use a commentary retrieval user interface to receive and display commentaries from the commentary server 110. The game player may be notified about an incoming commentary via a variety of methods, such as an icon on the screen, a banner alert, an audible alert, a vibration alert, and/or the like, and may choose to select or ignore the incoming commentary, e.g., a stream of scrolling messages. The game player may respond to commentaries via, for example, short message service (SMS), email, instant messaging, social media platforms, and/or the like. The commentary responses may be communicated from the game player (e.g., the user device 104 of the game player) to the game spectator (e.g., the user device 108 of the game spectator) via the commentary server 110.

The commentary input user interface and the commentary retrieval user interface may be implemented as components of an application executing on the user devices 104, 108. The commentary input user interface and the commentary retrieval user interface may be implemented as different applications executing on the user devices 104, 108. The commentary input user interface may, for example, be part of a game viewing application executing on a user device 108, or may be part of a commentary application separate from the game viewing application. The commentary retrieval user interface may, for example, be part of a gaming application executing on user device 104, or may be part of an application separate from the gaming application. Such applications may be installable applications, or may be running in a web browser on the user devices 104, 108.

A game spectator may watch a game, e.g., a media of the game, using a game viewing user interface executing on a user device 108. The game spectator may create commentaries to one or more individual game players through the commentary input user interface of a commentary application executing on the user device 108. The commentary input user interface may allow the game spectator to specify information including, for example, content, keywords (e.g., coaching advice, compliments, questions, general observations, etc.), time sensitivity (e.g., urgent, may be delivered offline), a list of recipients (e.g., an individual player, an individual player and a spectator social network, and/or a list of individuals), and/or a privacy level per recipient (e.g., highly private, semi-private, public). Information may be inferred by the commentary application or may be associated with a default value if it is not explicitly provided by the game spectator. After the commentary is created, the commentary application may send the commentary to the commentary server 110 for processing (i.e., tagging and/or filtering). The commentary server 110 may be cloud-based.

A game player may play the game using a game playing user interface executing on a user device 104. The game player may receive commentaries through the commentary retrieval user interface executing on the user device 104.

The commentary server 110 may process the commentary, e.g., before the commentary reaches the user device 104. A game player may learn that a commentary is available, for example, by accessing the commentary server 110 or by being notified by the commentary server 110, e.g., via a pull notification or a push notification.

Matching between a game player and an available commentary or commentaries may be performed by an information filter or filters, e.g., the filtering subsystem 116, which may evaluate the profile of the game player. The information filter or filters may evaluate a query (e.g., “I need help with strategy,” “what resource should I buy next,” “why am I losing?”). A query capability for the system may be supported by a range of state of the art technologies (such as, for example, a built in set of questions that will produce answers relevant to the user, a sophisticated natural language search, or a database of commentary with capability to parse the query and match it against existing commentary (e.g., similar to the capabilities of Google search)).

The game player may read a commentary if he or she wishes. The user device 104 may convert text to speech for commentary that is not already in an audio format. The commentary input and retrieval may occur substantially simultaneously, e.g., the game spectator may provide commentary for the game player substantially in real time.

The game player may view the received commentaries in real time or at a later time, e.g., offline or online after the end of a game. The game may be recorded and/or saved for future viewing (e.g., replay). The game player and/or others may view the commentaries during a replay session.

Commentaries may be individually addressable, personalized, searchable, and/or tagged. Commentaries may be shared with one or more social networks.

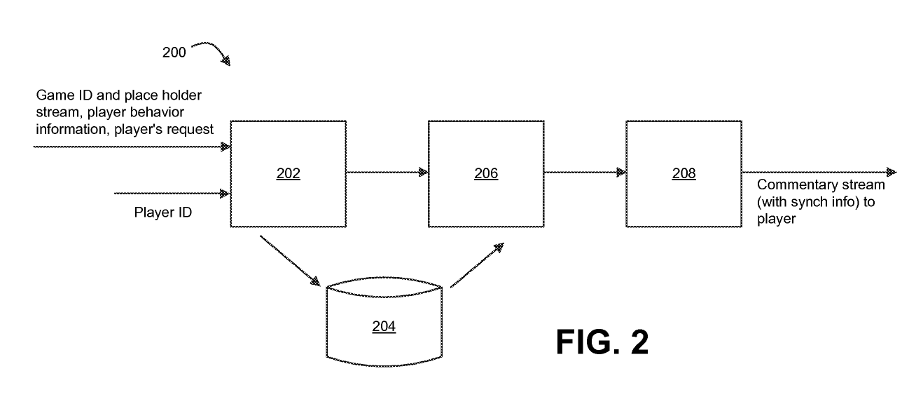

FIG. 2 illustrates an example process 200 for evaluating which commentaries to forward to a player. A commentary directed at a player may arrive at a commentary server. Information such as Player ID, Game ID and place holder stream, player behavior information, player's request may be input into the server.

At 202, the state and context of the player may be evaluated, for example, based on various inputs and/or sensor information. Information may include the player(s), context, and state of the game. Information may include whether the player is winning or losing the game, whether the player is currently active or passive, whether the player welcomes comments and from whom the player may welcome comments (e.g., from specific individuals, from types of spectators, etc.). Information relating to the state and context of the player may be stored in a database 204. Information relating to the player's profile and game state info may be stored in a database 204.

At 206, the information may be used to make a decision as to whether to forward the commentary to the player and, if so, at what time. Discovery may be performed to determine whether to forward the commentary to the player. Filtering rules may be applied to determine whether to forward the commentary to the player. Scheduling may be performed to determine when to forward the commentary to the player.

At 208, if the player, spectator, and/or members of a social network may be viewing the game offline (e.g., as recorded media or in a replay mode), the commentaries may be synchronized with correct temporal and/or spatial positions in the game media. Presentation, synchronicity, and/or session management may be performed. The commentary may be forwarded to the player (either in real time or later).

A game player may be able to interact with commentaries. For example, the user interface for the game player may allow the game player to skip to a next comment or review a previous comment if multiple comments are available. The game player may be able to provide a rating of the commentary, e.g., thumbs up or down, like or dislike, ratings, and/or reply comments. Comments may be linked to other comments. For example, comments may be associated with tags that may relate to tags in different parts of the game.

The game player may control the look and feel of the comments. For example, some comments may be announced through audio, while other comments may be presented using graphic overlays. Some comments may be accompanied by haptic feedback, e.g., vibration of the device or a controller. These presentation options may be specified, for example, by player profile preferences, and/or may be affected by the availability of the commentary in a particular (e.g., audio or visual) form.

Comments may be visualized according to groups of related comments. For example, comments from a first spectator may be presented in a color (for example, yellow). Comments from a second spectator may be presented in another color (for example, green).

Comments may be enabled or disabled at selected points (e.g., any point) in the game. This may be performed on a global basis or on a per user basis. For example, individual commentators may be muted or ignored at selected points (e.g., any point) in the game using, for example, game controls or voice recognition (e.g., the player may state, “ignore X”). Commentators who are muted or ignored may or may not be notified of that fact. They may be told that they were ignored in real time but that their commentary may be saved in the commentary database for possible future viewing, e.g., if the game is replayed. They may be told that their commentaries are ignored altogether. The commentator may receive a reason why the player is muting or ignoring his or her commentary. For example, the commentator may be informed that the player is not accepting any commentary at the time, or that the player is only accepting commentary from certain players, e.g., players of a certain level of credential or expertise in the game, players known to the player, etc.

As part of the tagging process, comments may undergo sentiment analysis and may be tagged according to the sentiment they convey. For example, comments may be categorized as positive, encouraging, negative, abusive, constructive, etc. The player may be able to choose which type or types of sentiments he or she would like to be exposed to through the commentaries during the game. For example, the player may specify that he or she only desires to receive constructive comments.

Comments may be streamed in real time. For example, Really Simple Syndication (RSS), a publish subscribe mechanism, may be used to stream comments. Social media search functions, e.g., search from the TWITTER® service, may be employed to make comments available. If commentary is broadcast to a group in a social network, the list of people in the group may be available for viewing by the players in the group.

The commentary server may be located in the cloud (e.g., a public cloud, a private cloud, a data center, or the like), and the service may be provided without a functional or business association with the game publisher or the game server. The commentary server may be owned and/or operated by the game publisher. The commentary server may be functionally and/or physically collocated with the game server. The commentary server may be owned and operated by a third party whose sole function is to provide the service. The commentary server may be owned by a third party that offers a generic communications platform such as IoT bus infrastructure. The commentary server may be owned by a third party application provider such as twitch (www.twitch.tv) that can offer, in addition to their normal services of offering games as spectator sport, a commentary server and associated functionality as described herein.

Commentary may be created and/or produced in a commentary production environment that may be integrated into a standalone game application. Commentary may be created and/or produced in a commentary production environment that may comprise a web browser plug-in. Commentary may be created and/or produced in other commentary production environments.

A spectator may watch a game in a game application. The game application may have an application component that allows the spectator to input text, graphics, voice, video, hyperlinks, emoticons, and/or other artifacts. The spectator may be able to modify the appearance of artifacts, for example, by changing their fonts, colors, etc. After creating a comment, the spectator may publish it, for example, by clicking on a Publish button or a similar control. When the spectator publishes the commentary, the commentary may be packaged and/or time stamped. Time stamping the commentary may allow the commentary to be associated with the timeline of the game.

A comment may comprise envelope information (e.g., metadata) as disclosed herein. Metadata may be included such as “buy resources,” “change strategy,” etc. The names of the tags may be at the discretion of the commentator.

A spectator may make multiple comments while watching a game. A series of comments may be associated with the game. Comments may be self-contained pieces of code that may include timestamp information. A commentary application may replay comments in synchronization with a recorded game to recreate an enriched media experience.

Commentary may be distributed and/or filtered. Comments may be stored on network servers that may be a part of the commentary server. Comments may be stored in other locations that may be accessible to the service.

Comments may be distributed via a number of online synchronization and distribution techniques, such as RSS, ATOM, and the like.

Comments may be available for searching by game players and/or other spectators. Searching may be performed by keywords, by the name of the spectator and/or his or her type and credentials (e.g., expert in the game, has a certain position at the leaderboard statistics (e.g., highest score), has a certain character level), tags, and/or other elements.

Comments may be filtered, for example, based on the comment media type (e.g., text, audio, video, graphics, etc.). Users may convert one media type to another (e.g., text to speech, speech to text). Users may ask to explicitly ignore individual commentators or commentator types, and the ignored commentator may be notified about it.

Filters may be used to filter out profanities in comments. Spectators who send commentaries that comprise profanity may be placed (e.g., automatically) in the “ignore” list. Such spectators may be notified of the reason their commentaries are blocked, for example, to reduce or prevent such behavior in the future.

Comments may be rendered in a number of different modes. For example, they may be rendered as text, as audio (e.g., speech), as graphics, as haptic feedback, etc.

Spectators may be able to offer and/or provide personalized commentary to players in real-time, as well as resources. Resources may be monetary, which the player may use to purchase items, such as levels, power ups, or other items that may provide the player with an advantage in the game. Resources may be items, such as levels, power ups, or other items, if the spectator has the ability to purchase them. The commentary server may provide a service that executes a transaction or transactions to transfer resources to a player. The transaction mechanism may follow a similar path as disclosed herein in connection with FIG. 2. The player may have an option to filter offers based on similar criteria as used to filter commentary. Other filtering criteria may be used, such as criteria related to transaction size and type (e.g., money, game items).

Game players may be able to monetize their game play. For example, a service associated with the commentary server may broker professional commentators to provide commentary for expert gamers in return for a fee payable to both. Spectators may pay to watch expert game players play and expert commentators commenting on the game similarly to broadcasts of professional sports.

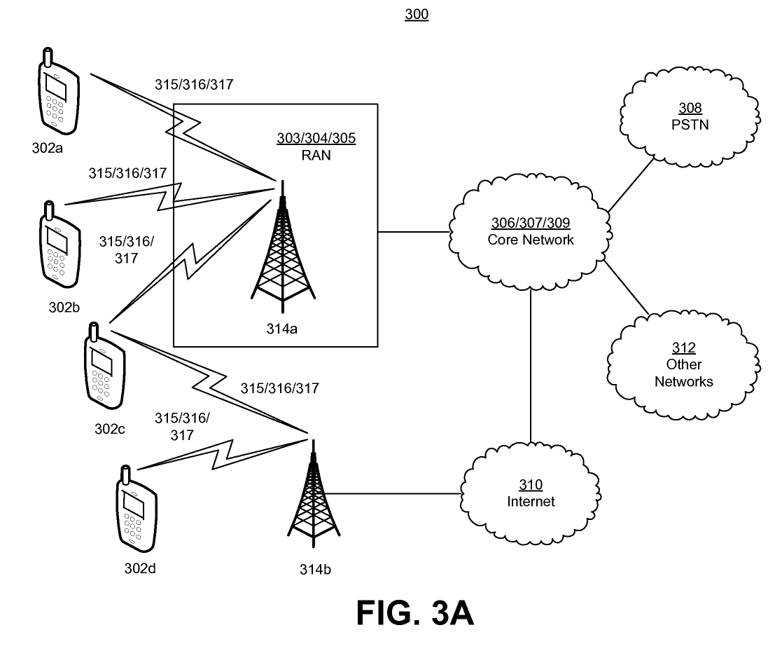

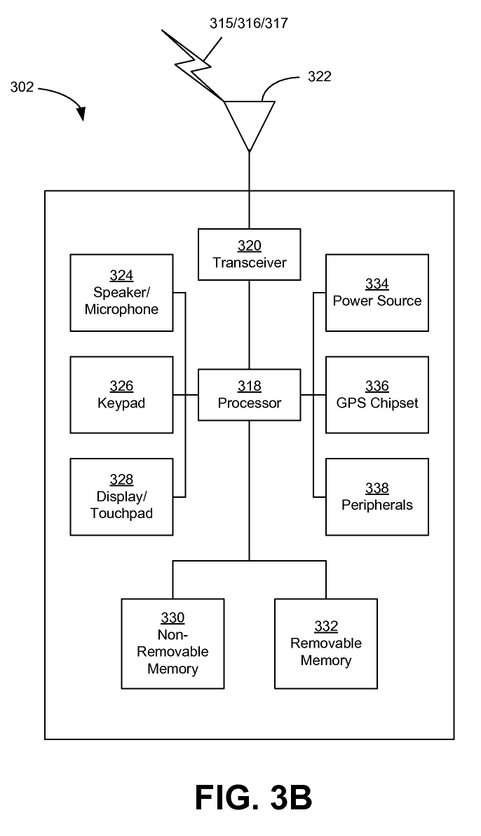

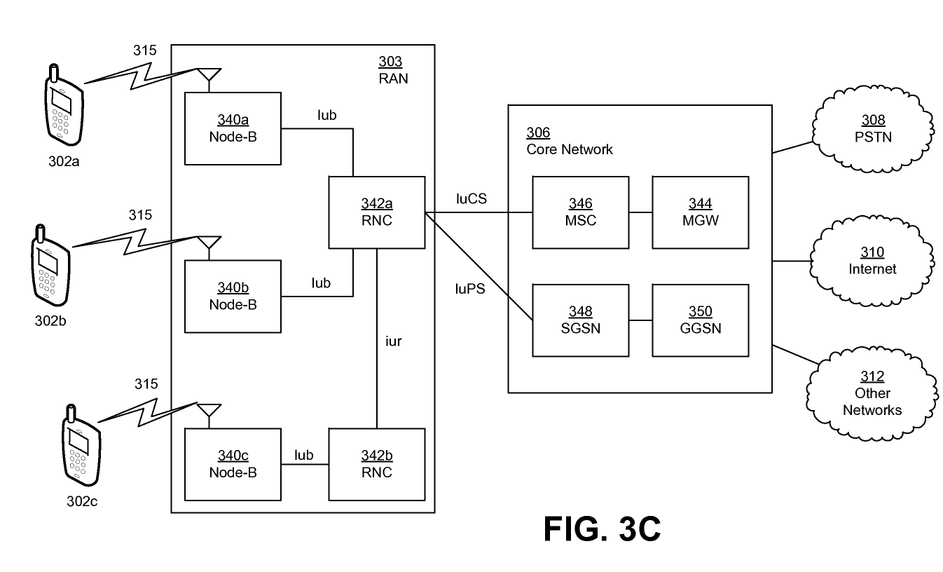

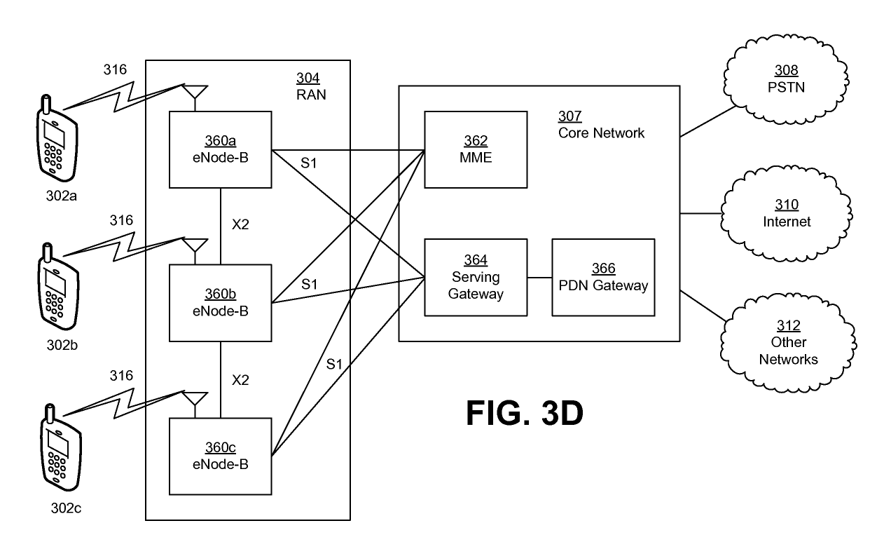

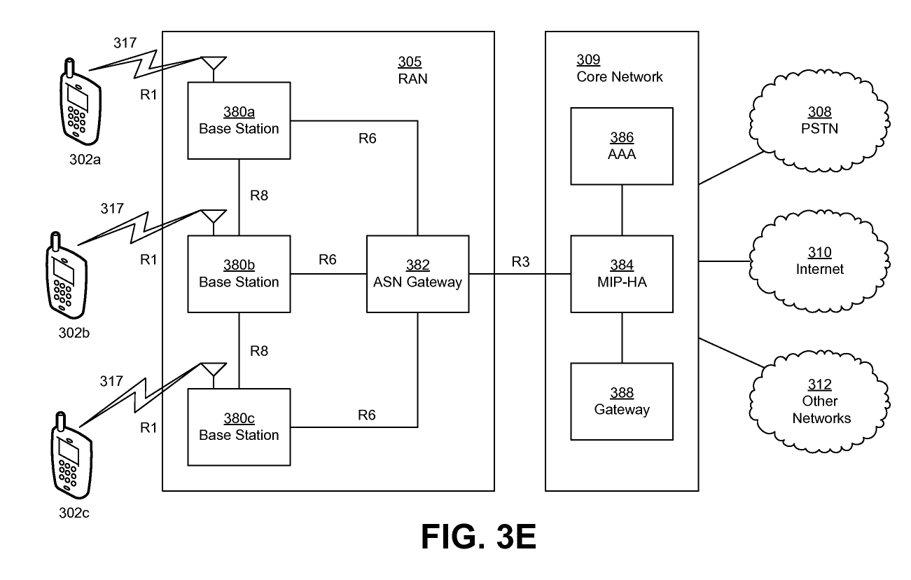

FIG. 3A is a diagram of an example communications system 300 in which one or more disclosed embodiments may be implemented. The communications system 300 may be a multiple access system that provides content, such as voice, data, video, messaging, broadcast, etc., to multiple wireless users. The communications system 300 may enable multiple wireless users to access such content through the sharing of system resources, including wireless bandwidth. For example, the communications system 300 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 3A, the communications system 300 may include wireless transmit/receive units (WTRUs) 302a, 302b, 302c, and/or 302d (which generally or collectively may be referred to as WTRU 302), a radio access network (RAN) 303/304/305, a core network 306/307/309, a public switched telephone network (PSTN) 308, the Internet 310, and other networks 312, though it will be appreciated that the disclosed embodiments contemplate any number of WTRUs, base stations, networks, and/or network elements. Each of the WTRUs 302a, 302b, 302c, 302d may be any type of device configured to operate and/or communicate in a wireless environment. By way of example, the WTRUs 302a, 302b, 302c, 302d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 300 may also include a base station 314a and a base station 314b. Each of the base stations 314a, 314b may be any type of device configured to wirelessly interface with at least one of the WTRUs 302a, 302b, 302c, 302d to facilitate access to one or more communication networks, such as the core network 306/107/309, the Internet 310, and/or the networks 312. By way of example, the base stations 314a, 314b may be a base transceiver station (BTS), a Node-B, an eNode B, a Home Node B, a Home eNode B, a site controller, an access point (AP), a wireless router, and the like. While the base stations 314a, 314b are each depicted as a single element, it will be appreciated that the base stations 314a, 314b may include any number of interconnected base stations and/or network elements.

The base station 314a may be part of the RAN 303/304/305, which may also include other base stations and/or network elements (not shown), such as a base station controller (BSC), a radio network controller (RNC), relay nodes, etc. The base station 314a and/or the base station 314b may be configured to transmit and/or receive wireless signals within a particular geographic region, which may be referred to as a cell (not shown). The cell may further be divided into cell sectors. For example, the cell associated with the base station 314a may be divided into three sectors. Thus, in one embodiment, the base station 314a may include three transceivers, e.g., one for each sector of the cell. In another embodiment, the base station 314a may employ multiple-input multiple output (MIMO) technology and, therefore, may utilize multiple transceivers for each sector of the cell.

The base stations 314a, 314b may communicate with one or more of the WTRUs 302a, 302b, 302c, 302d over an air interface 315/316/317, which may be any suitable wireless communication link (e.g., radio frequency (RF), microwave, infrared (IR), ultraviolet (UV), visible light, etc.). The air interface 315/316/317 may be established using any suitable radio access technology (RAT).

More specifically, as noted above, the communications system 300 may be a multiple access system and may employ one or more channel access schemes, such as CDMA, TDMA, FDMA, OFDMA, SC-FDMA, and the like. For example, the base station 314a in the RAN 303/304/305 and the WTRUs 302a, 302b, 302c may implement a radio technology such as Universal Mobile Telecommunications System (UMTS) Terrestrial Radio Access (UTRA), which may establish the air interface 315/316/317 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 314a and the WTRUs 302a, 302b, 302c may implement a radio technology such as Evolved UMTS Terrestrial Radio Access (E-UTRA), which may establish the air interface 315/316/317 using Long Term Evolution (LTE) and/or LTE-Advanced (LTE-A).

In other embodiments, the base station 314a and the WTRUs 302a, 302b, 302c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 314b in FIG. 3A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 314b and the WTRUs 302c, 302d may implement a radio technology such as IEEE 802.11 to establish a wireless local area network (WLAN). In another embodiment, the base station 314b and the WTRUs 302c, 302d may implement a radio technology such as IEEE 802.15 to establish a wireless personal area network (WPAN). In yet another embodiment, the base station 314b and the WTRUs 302c, 302d may utilize a cellular-based RAT (e.g., WCDMA, CDMA2000, GSM, LTE, LTE-A, etc.) to establish a picocell or femtocell. As shown in FIG. 3A, the base station 314b may have a direct connection to the Internet 310. Thus, the base station 314b may not be required to access the Internet 310 via the core network 306/307/309.

The RAN 303/304/305 may be in communication with the core network 306/307/309, which may be any type of network configured to provide voice, data, applications, and/or voice over internet protocol (VoIP) services to one or more of the WTRUs 302a, 302b, 302c, 302d. For example, the core network 306/307/309 may provide call control, billing services, mobile location-based services, pre-paid calling, Internet connectivity, video distribution, etc., and/or perform high-level security functions, such as user authentication. Although not shown in FIG. 3A, it will be appreciated that the RAN 303/304/305 and/or the core network 306/307/309 may be in direct or indirect communication with other RANs that employ the same RAT as the RAN 303/304/305 or a different RAT. For example, in addition to being connected to the RAN 303/304/305, which may be utilizing an E-UTRA radio technology, the core network 306/307/309 may also be in communication with another RAN (not shown) employing a GSM radio technology.

The core network 306/307/309 may also serve as a gateway for the WTRUs 302a, 302b, 302c, 302d to access the PSTN 308, the Internet 310, and/or other networks 312. The PSTN 308 may include circuit-switched telephone networks that provide plain old telephone service (POTS). The Internet 310 may include a global system of interconnected computer networks and devices that use common communication protocols, such as the transmission control protocol (TCP), user datagram protocol (UDP) and the internet protocol (IP) in the TCP/IP internet protocol suite. The networks 312 may include wired or wireless communications networks owned and/or operated by other service providers. For example, the networks 312 may include another core network connected to one or more RANs, which may employ the same RAT as the RAN 303/304/305 or a different RAT.

Some or all of the WTRUs 302a, 302b, 302c, 302d in the communications system 300 may include multi-mode capabilities, e.g., the WTRUs 302a, 302b, 302c, 302d may include multiple transceivers for communicating with different wireless networks over different wireless links. For example, the WTRU 302c shown in FIG. 3A may be configured to communicate with the base station 314a, which may employ a cellular-based radio technology, and with the base station 314b, which may employ an IEEE 802 radio technology.

FIG. 3B is a system diagram of an example WTRU 302. As shown in FIG. 3B, the WTRU 302 may include a processor 318, a transceiver 320, a transmit/receive element 322, a speaker/microphone 324, a keypad 326, a display/touchpad 328, non-removable memory 330, removable memory 332, a power source 334, a global positioning system (GPS) chipset 336, and other peripherals 338. It will be appreciated that the WTRU 302 may include any sub-combination of the foregoing elements while remaining consistent with an embodiment. Also, embodiments contemplate that the base stations 314a and 314b, and/or the nodes that base stations 314a and 314b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 3B and described herein.

The processor 318 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 318 may perform signal coding, data processing, power control, input/output processing, and/or any other functionality that enables the WTRU 302 to operate in a wireless environment. The processor 318 may be coupled to the transceiver 320, which may be coupled to the transmit/receive element 322. While FIG. 3B depicts the processor 318 and the transceiver 320 as separate components, it will be appreciated that the processor 318 and the transceiver 320 may be integrated together in an electronic package or chip. A processor, such as the processor 318, may include integrated memory (e.g., WTRU 302 may include a chipset that includes a processor and associated memory). Memory may refer to memory that is integrated with a processor (e.g., processor 318) or memory that is otherwise associated with a device (e.g., WTRU 302). The memory may be non-transitory. The memory may include (e.g., store) instructions that may be executed by the processor (e.g., software and/or firmware instructions). For example, the memory may include instructions that when executed may cause the processor to implement one or more of the implementations described herein.

The transmit/receive element 322 may be configured to transmit signals to, or receive signals from, a base station (e.g., the base station 314a) over the air interface 315/316/317. For example, in one embodiment, the transmit/receive element 322 may be an antenna configured to transmit and/or receive RF signals. In another embodiment, the transmit/receive element 322 may be an emitter/detector configured to transmit and/or receive IR, UV, or visible light signals, for example. In yet another embodiment, the transmit/receive element 322 may be configured to transmit and receive both RF and light signals. It will be appreciated that the transmit/receive element 322 may be configured to transmit and/or receive any combination of wireless signals.

In addition, although the transmit/receive element 322 is depicted in FIG. 3B as a single element, the WTRU 302 may include any number of transmit/receive elements 322. More specifically, the WTRU 302 may employ MIMO technology. Thus, in one embodiment, the WTRU 302 may include two or more transmit/receive elements 322 (e.g., multiple antennas) for transmitting and receiving wireless signals over the air interface 315/316/317.

The transceiver 320 may be configured to modulate the signals that are to be transmitted by the transmit/receive element 322 and to demodulate the signals that are received by the transmit/receive element 322. As noted above, the WTRU 302 may have multi-mode capabilities. Thus, the transceiver 320 may include multiple transceivers for enabling the WTRU 302 to communicate via multiple RATs, such as UTRA and IEEE 802.11, for example.

The processor 318 of the WTRU 302 may be coupled to, and may receive user input data from, the speaker/microphone 324, the keypad 326, and/or the display/touchpad 328 (e.g., a liquid crystal display (LCD) display unit or organic light-emitting diode (OLED) display unit). The processor 318 may also output user data to the speaker/microphone 324, the keypad 326, and/or the display/touchpad 328. In addition, the processor 318 may access information from, and store data in, any type of suitable memory, such as the non-removable memory 330, the removable memory 332, and/or memory integrated with the processor 318. The non-removable memory 330 may include random-access memory (RAM), read-only memory (ROM), a hard disk, or any other type of memory storage device. The removable memory 332 may include a subscriber identity module (SIM) card, a memory stick, a secure digital (SD) memory card, and the like. In other embodiments, the processor 318 may access information from, and store data in, memory that is not physically located on the WTRU 302, such as on a server or a home computer (not shown).

The processor 318 may receive power from the power source 334, and may be configured to distribute and/or control the power to the other components in the WTRU 302. The power source 334 may be any suitable device for powering the WTRU 302. For example, the power source 334 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 318 may also be coupled to the GPS chipset 336, which may be configured to provide location information (e.g., longitude and latitude) regarding the current location of the WTRU 302. In addition to, or in lieu of, the information from the GPS chipset 336, the WTRU 302 may receive location information over the air interface 315/316/317 from a base station (e.g., base stations 314a, 314b) and/or determine its location based on the timing of the signals being received from two or more nearby base stations. It will be appreciated that the WTRU 302 may acquire location information by way of any suitable location-determination implementation while remaining consistent with an embodiment.

The processor 318 may further be coupled to other peripherals 338, which may include one or more software and/or hardware modules that provide additional features, functionality and/or wired or wireless connectivity. For example, the peripherals 338 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 3C is a system diagram of the RAN 303 and the core network 306 according to an embodiment. As noted above, the RAN 303 may employ a UTRA radio technology to communicate with the WTRUs 302a, 302b, 302c over the air interface 315. The RAN 303 may also be in communication with the core network 306. As shown in FIG. 3C, the RAN 303 may include Node-Bs 340a, 340b, 340c, which may each include one or more transceivers for communicating with the WTRUs 302a, 302b, 302c over the air interface 315. The Node-Bs 340a, 340b, 340c may each be associated with a particular cell (not shown) within the RAN 303. The RAN 303 may also include RNCs 342a, 342b. It will be appreciated that the RAN 303 may include any number of Node-Bs and RNCs while remaining consistent with an embodiment.

As shown in FIG. 3C, the Node-Bs 340a, 340b may be in communication with the RNC 342a. Additionally, the Node-B 340c may be in communication with the RNC 342b. The Node-Bs 340a, 340b, 340c may communicate with the respective RNCs 342a, 342b via an Iub interface. The RNCs 342a, 342b may be in communication with one another via an Iur interface. Each of the RNCs 342a, 342b may be configured to control the respective Node-Bs 340a, 340b, 340c to which it is connected. In addition, each of the RNCs 342a, 342b may be configured to carry out or support other functionality, such as outer loop power control, load control, admission control, packet scheduling, handover control, macrodiversity, security functions, data encryption, and the like.

The core network 306 shown in FIG. 3C may include a media gateway (MGW) 344, a mobile switching center (MSC) 346, a serving GPRS support node (SGSN) 348, and/or a gateway GPRS support node (GGSN) 350. While each of the foregoing elements are depicted as part of the core network 306, it will be appreciated that any one of these elements may be owned and/or operated by an entity other than the core network operator.

The RNC 342a in the RAN 303 may be connected to the MSC 346 in the core network 306 via an IuCS interface. The MSC 346 may be connected to the MGW 344. The MSC 346 and the MGW 344 may provide the WTRUs 302a, 302b, 302c with access to circuit-switched networks, such as the PSTN 308, to facilitate communications between the WTRUs 302a, 302b, 302c and traditional land-line communications devices.

The RNC 342a in the RAN 303 may also be connected to the SGSN 348 in the core network 306 via an IuPS interface. The SGSN 348 may be connected to the GGSN 350. The SGSN 348 and the GGSN 350 may provide the WTRUs 302a, 302b, 302c with access to packet-switched networks, such as the Internet 310, to facilitate communications between and the WTRUs 302a, 302b, 302c and IP-enabled devices.

As noted above, the core network 306 may also be connected to the networks 312, which may include other wired or wireless networks that are owned and/or operated by other service providers.

FIG. 3D is a system diagram of the RAN 304 and the core network 307 according to an embodiment. As noted above, the RAN 304 may employ an E-UTRA radio technology to communicate with the WTRUs 302a, 302b, 302c over the air interface 316. The RAN 304 may also be in communication with the core network 307.

The RAN 304 may include eNode-Bs 360a, 360b, 360c, though it will be appreciated that the RAN 304 may include any number of eNode-Bs while remaining consistent with an embodiment. The eNode-Bs 360a, 360b, 360c may each include one or more transceivers for communicating with the WTRUs 302a, 302b, 302c over the air interface 316. In one embodiment, the eNode-Bs 360a, 360b, 360c may implement MIMO technology. Thus, the eNode-B 360a, for example, may use multiple antennas to transmit wireless signals to, and receive wireless signals from, the WTRU 302a.

Each of the eNode-Bs 360a, 360b, 360c may be associated with a particular cell (not shown) and may be configured to handle radio resource management decisions, handover decisions, scheduling of users in the uplink and/or downlink, and the like. As shown in FIG. 3D, the eNode-Bs 360a, 360b, 360c may communicate with one another over an X2 interface.

The core network 307 shown in FIG. 3D may include a mobility management gateway (MME) 362, a serving gateway 364, and a packet data network (PDN) gateway 366. While each of the foregoing elements are depicted as part of the core network 307, it will be appreciated that any one of these elements may be owned and/or operated by an entity other than the core network operator.

The MME 362 may be connected to each of the eNode-Bs 360a, 360b, 360c in the RAN 304 via an S1 interface and may serve as a control node. For example, the MME 362 may be responsible for authenticating users of the WTRUs 302a, 302b, 302c, bearer activation/deactivation, selecting a particular serving gateway during an initial attach of the WTRUs 302a, 302b, 302c, and the like. The MME 362 may also provide a control plane function for switching between the RAN 304 and other RANs (not shown) that employ other radio technologies, such as GSM or WCDMA.

The serving gateway 364 may be connected to each of the eNode-Bs 360a, 360b, 360c in the RAN 304 via the S1 interface. The serving gateway 364 may generally route and forward user data packets to/from the WTRUs 302a, 302b, 302c. The serving gateway 364 may also perform other functions, such as anchoring user planes during inter-eNode B handovers, triggering paging when downlink data is available for the WTRUs 302a, 302b, 302c, managing and storing contexts of the WTRUs 302a, 302b, 302c, and the like.

The serving gateway 364 may also be connected to the PDN gateway 366, which may provide the WTRUs 302a, 302b, 302c with access to packet-switched networks, such as the Internet 310, to facilitate communications between the WTRUs 302a, 302b, 302c and IP-enabled devices.

The core network 307 may facilitate communications with other networks. For example, the core network 307 may provide the WTRUs 302a, 302b, 302c with access to circuit-switched networks, such as the PSTN 308, to facilitate communications between the WTRUs 302a, 302b, 302c and traditional land-line communications devices. For example, the core network 307 may include, or may communicate with, an IP gateway (e.g., an IP multimedia subsystem (IMS) server) that serves as an interface between the core network 307 and the PSTN 308. In addition, the core network 307 may provide the WTRUs 302a, 302b, 302c with access to the networks 312, which may include other wired or wireless networks that are owned and/or operated by other service providers.

FIG. 3E is a system diagram of the RAN 305 and the core network 309 according to an embodiment. The RAN 305 may be an access service network (ASN) that employs IEEE 802.16 radio technology to communicate with the WTRUs 302a, 302b, 302c over the air interface 317. As will be further discussed below, the communication links between the different functional entities of the WTRUs 302a, 302b, 302c, the RAN 305, and the core network 309 may be defined as reference points.

As shown in FIG. 3E, the RAN 305 may include base stations 380a, 380b, 380c, and an ASN gateway 382, though it will be appreciated that the RAN 305 may include any number of base stations and ASN gateways while remaining consistent with an embodiment. The base stations 380a, 380b, 380c may each be associated with a particular cell (not shown) in the RAN 305 and may each include one or more transceivers for communicating with the WTRUs 302a, 302b, 302c over the air interface 317. In one embodiment, the base stations 380a, 380b, 380c may implement MIMO technology. Thus, the base station 380a, for example, may use multiple antennas to transmit wireless signals to, and receive wireless signals from, the WTRU 302a. The base stations 380a, 380b, 380c may also provide mobility management functions, such as handoff triggering, tunnel establishment, radio resource management, traffic classification, quality of service (QoS) policy enforcement, and the like. The ASN gateway 382 may serve as a traffic aggregation point and may be responsible for paging, caching of subscriber profiles, routing to the core network 309, and the like.

The air interface 317 between the WTRUs 302a, 302b, 302c and the RAN 305 may be defined as an R1 reference point that implements the IEEE 802.16 specification. In addition, each of the WTRUs 302a, 302b, 302c may establish a logical interface (not shown) with the core network 309. The logical interface between the WTRUs 302a, 302b, 302c and the core network 309 may be defined as an R2 reference point, which may be used for authentication, authorization, IP host configuration management, and/or mobility management.

The communication link between each of the base stations 380a, 380b, 380c may be defined as an R8 reference point that includes protocols for facilitating WTRU handovers and the transfer of data between base stations. The communication link between the base stations 380a, 380b, 380c and the ASN gateway 382 may be defined as an R6 reference point. The R6 reference point may include protocols for facilitating mobility management based on mobility events associated with each of the WTRUs 302a, 302b, 302c.

As shown in FIG. 3E, the RAN 305 may be connected to the core network 309. The communication link between the RAN 305 and the core network 309 may defined as an R3 reference point that includes protocols for facilitating data transfer and mobility management capabilities, for example. The core network 309 may include a mobile IP home agent (MIP-HA) 384, an authentication, authorization, accounting (AAA) server 386, and a gateway 388. While each of the foregoing elements are depicted as part of the core network 309, it will be appreciated that any one of these elements may be owned and/or operated by an entity other than the core network operator.

The MIP-HA may be responsible for IP address management, and may enable the WTRUs 302a, 302b, 302c to roam between different ASNs and/or different core networks. The MIP-HA 384 may provide the WTRUs 302a, 302b, 302c with access to packet-switched networks, such as the Internet 310, to facilitate communications between the WTRUs 302a, 302b, 302c and IP-enabled devices. The AAA server 386 may be responsible for user authentication and for supporting user services. The gateway 388 may facilitate interworking with other networks. For example, the gateway 388 may provide the WTRUs 302a, 302b, 302c with access to circuit-switched networks, such as the PSTN 308, to facilitate communications between the WTRUs 302a, 302b, 302c and traditional land-line communications devices. In addition, the gateway 388 may provide the WTRUs 302a, 302b, 302c with access to the networks 312, which may include other wired or wireless networks that are owned and/or operated by other service providers.

Although not shown in FIG. 3E, it will be appreciated that the RAN 305 may be connected to other ASNs and the core network 309 may be connected to other core networks. The communication link between the RAN 305 the other ASNs may be defined as an R4 reference point, which may include protocols for coordinating the mobility of the WTRUs 302a, 302b, 302c between the RAN 305 and the other ASNs. The communication link between the core network 309 and the other core networks may be defined as an R5 reference, which may include protocols for facilitating interworking between home core networks and visited core networks.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1. A method, comprising:
receiving a commentary over an interface established between a player of an application and a spectator viewing the application, wherein the spectator provides the commentary; and
comparing the commentary to a filtering criterion, and, if the commentary satisfies the filtering criterion, providing the commentary to the player.

2. The method of claim 1, further comprising associating the commentary with a tag.

3. The method of claim 1, wherein the commentary is filtered according to a preselected preference of the player.

4. The method of claim 1, wherein the commentary is filtered according to a credential of the spectator.

5. The method of claim 1, wherein the commentary is filtered according to an identity of the spectator.

6. The method of claim 1, wherein the commentary is filtered according to a topic of the commentary.

7. The method of claim 1, wherein the commentary is filtered according to a tone of the commentary.

8. The method of claim 1, wherein the commentary is filtered according to a context of the player within the application.

9. The method of claim 8, wherein the context of the player comprises at least one of whether the player is winning in the application, whether the player is losing resources, whether the player is active, or whether the player is passive.

10. The method of claim 8, wherein the context of the player comprises whether the player invites advice.

11. The method of claim 1, wherein the commentary is provided to the player in real time.

12. The method of claim 1, further comprising synchronizing the commentary with a temporal location in media associated with the application.

13. The method of claim 1, further comprising archiving the commentary.

14. The method of claim 13, wherein the commentary is provided to the player after a conclusion of the application.

15. The method of claim 13, wherein the commentary is provided during a replay of a media associated with the application.

16. The method of claim 1, further comprising sending a request to the player to rate the commentary.

17. The method of claim 1, further comprising receiving, from the player, a rating related to the commentary.

18. A server, comprising:
a processor configured to:
receive a commentary over an interface established between a player of an application and a spectator viewing the application, wherein the spectator provides the commentary; and
compare the commentary to a filtering criterion, and, if the commentary satisfies the filtering criterion, provide the commentary to the player.

19. The server of claim 18, wherein the processor is further configured to associate the commentary with a tag.

20. The server of claim 18, wherein the processor is further configured to filter the commentary according to at least one of preselected preferences of the player, a credential of the spectator, identity of the spectator, topic of the commentary, and tone of the commentary.

21. The server of claim 18, wherein the processor is further configured to filter according to the player's context in the application.

22. The server of claim 21, wherein the context of the user comprises at least one of whether the player is winning the game, whether the player is losing resources, whether the player is active, and whether the player is passive.

23. The server of claim 21, wherein the context of the user comprises whether the player invites advice.

24. The server of claim 18, wherein the processor is further configured to provide the commentary in real time.

25. The server of claim 18, wherein the processor is further configured to synchronize the commentary with a temporal location in media associated with the application

26. The server of claim 18, wherein the processor is further configured to archive the commentary.

27. The server of claim 26, wherein the processor is further configured to provide the commentary after a conclusion of the application.

28. The server of claim 26, wherein the processor is further configured to provide the commentary during a replay of a media associated with the application.

29. The server of claim 18, wherein the processor is further configured to send a request to the player to rate the commentary.

30. The server of claim 18, wherein the processor is further configured to receive, from the player, a rating related to the commentary.
